(19) United States
(12) Patent Application Publication
(10) Pub. No.: US 2021/0316424 A1
(43) Pub. Date: Oct. 14, 2021

(54) WIGO

(71) Applicant: Tieron Mackinnon, Baltimore, MD (US)

(72) Inventor: Tieron Mackinnon, Baltimore, MD (US)

(21) Appl. No.: 16/843,663

(22) Filed: Apr. 8, 2020

(51) Int. Cl. B25B 21/00; B25B 19/00

(52) U.S. Cl. CPC B25B 21/004; B25B 19/00

(57) ABSTRACT

Cordless ratchet wrench is designed with the various upgrades in its design from the previously available cordless ratchet wrench. The ratchet actuator, which was a motor, the direction for the rotation of the output shaft was easily adjusted. A battery was used in the new design to provide the power for the rotation of the shaft for tightening and losing purpose. The push-button was used to trigger the rotation of the shaft for the tightening or the losing purpose. The pneumatic air ratchet wrench is the second model and it is also used as the latest electric wrench for the tightening and the losing purpose. The air motor is used in the design instead of the regular electric motor to make a pneumatic air ratchet wrench. The structure of the pneumatic air ratchet wrench is easily handleable at different locations.

### FIELD OF THE INVENTION

The art used in the design of this pneumatic air ratchet wrench is inspired by the rotary impact wrenches. The rotation of the output shaft in this pneumatic air ratchet wrench is reciprocated periodically into and out from the rotary impact. The torque of the output shaft is controlled with the help of a reverse switch in the air motor.

### BACKGROUND OF THE INVENTION

The idea of the pneumatic air ratchet wrench originated from the impact wrench. The air motor [4] is also called the pneumatic motor which is used in different mechanical work. The air motors convert the air energy into the mechanical energy which is used to rotate the output shaft of the wrench. The air motors are usually used in the handheld tools which are used at various locations that need the ease of the handling. The air motors are also used in the pulse tools, the impact wrenches, nut runners, grinders, screwdrivers. Hence the air motors or the pneumatic motors are extensively used for various handheld tools. In the developed model the same air motor or the pneumatic motor is used. This type of wrench is also cordless or the electric wrench which is operated with the help of the electric power in form of the air pressure. A battery can be also used to operate the electric motor but in this design the motor will be the air motor which is operated with the difference of the air pressure in the wrench. A good pilot arrangement is required in the design of the newly developed model in order to effectively control the motor. This wrench will work on the air pressure inside the wrench body. That is why the body for this type of wrench is airtight in order to effectively provide the enough air pressure to operate the wrench designed.

### SUMMARY OF THE INVENTION

The prior importance while designing the pneumatic air ratchet wrench was to keep the weight of the wrench as light as possible. For this purpose, the components with the lighter weight were used. The other important aspect kept in mind was the inertia. When the device is triggered the inertia is created among the parts of the wrench which is handled with the help of the casing of the developed model. The housing of the developed model includes the air motor and the other mechanical parts of the wrench. The proper casing for the air motor was developed in order to reduce the inertia experienced by the user. The different available casings for the pneumatic air ratchet wrench were studied and the new design was made to improve the different parameters from the previous models.

The head for this wrench will be changeable. The changeable heads for the air ratchet wrench allow to use the heads with the different sizes to tighten or loosen the different kind and types of the screws. In different hardware or tool, the standard bolt sizes and the standard screw sizes are used. The heads for the different standard sizes of the bolts and screws will be easily attachable to the designed wrench. The easy attachment of a new wrench head allows the user to attach or detach a head of desired bolt or screw size easily. The standard sizes of the heads for the bolts and screws will be used.

### Brief Description of Pneumatic Ratchet Wrench

FIG. 2 Rotary impact wrench is the basic inspiration behind all this work. It can be said that, this is the advance form of cordless ratchet wrench. The body [13] of this tool and cordless ratchet wrench is similar, but this tool still has extra parts and the features. By the concept of rotary impact, the rotation of the shaft can be performed as an output, to perform a dedicated task. By this a torque will be generated on the output shaft, this shaft is usually controlled with the use of a reverse switch in the air motor [17]. There is a body, in which all the circuitry and the hardware parts are present. By this, the whole parts can be united. At the top of the wrench a head [6] is connected, this is basically used for the holding purpose of a bolt, which does the work. The head of the wrench must be strong enough so that it can't be broken in doing any hard work. For the mechanical movement of the machinery there is a gear, that is connected with the terminal of the motor. This specific part of the wrench is known as planetary gear [8] part. The innovation in this wrench is basically the use of air motor, which keeps this wrench a better and a good wrench for working. The air motors [17] change the air into the form of mechanical work and by this kind of energy the output shaft can be rotated. In this wrench, the ease of working is very significant feature and this wrench can be used in any of the work. Pulse tools, impact wrenches, screw drivers and grinders are the practical applications where the air motor can be used as a key part. Generally, the air motor is utilized in handheld tools. This wrench is also similar to the cordless ratchet wrench, that is operated with the help of the electrical power in the form of air pressure. For the strong and the durable body, there are some side connections also to keep united the whole body. For the internal attachment of the tiny parts, small pins [14] are used. For the effective controlling of this wrench a better pilot arrangement is required. This body of the wrench is kept airtight, so that each tiny pressure of air can derive the motor effectively. The lighter components are used to keep the weight of the wrench lighter, for the effective working. When the device is triggered [2] the inertia is created among the parts of the wrench which is handled with the help of the casing of the developed model.

In the housing of this wrench, air motor and the other mechanical parts are included. To minimize the level of inertia, the proper casing for the air motor was developed. The different available casings for the pneumatic air ratchet wrench were studied and the new design was made to improve the different parameters from the previous models. This wrench also has a changeable head, which allows to use the heads with the different sizes to tighten or loosen the different bolts. In the professional working, the standard and metric bolt sizes are used. The heads for the different standard sizes of the bolts and screws will be easily attachable to the designed wrench. There is also an option of extra-attachments, by this concept the head of the wrench can be changed according to the desired bolt size.

### Brief Description of Cordless Ratchet Wrench

This latest wrench, equipped with the battery, is generally used to assemble, or disassemble several hardware components with ease. This particular model of the wrench comparatively has many of the advanced features. By these features the time of the user can be saved, the quality work can be done and most importantly the safety of the user can be insured. That's why this item has novelty. A cordless ratchet wrench is designed with the various upgrades in its design from the previously available cordless ratchet wrench. The ratchet actuator is used in the newly developed design of the cordless ratchet wrench. The ratchet motor [4] was used to control the direction of the output shaft. With the help of the ratchet actuator, which was a motor, the direction for the rotation of the output shaft was easily adjusted. This newly developed technique is used to hold different rotating heads [1] for usage. The desired tool or the hardware like the nut or bolt can be easily tightened or loosed with the help of the ratchet actuator. The ratcheting motion of the developed ratchet wrench is easily controlled. A battery was used in the new design to provide the power for the rotation of the shaft for tightening and losing purpose. The power and capacity of the battery were used to rotate the ratchet which can be varied with the increasing size or the capacity of the battery. The newly developed model of the cordless ratchet wrench is easy to use with the increased performance as compared to the available models of the ratchet wrench. The push-button was used to trigger the rotation of the shaft for the tightening or the losing purpose of the attached hardware. The battery also prevents the reverse flow of the rotating shaft in case of the torque experienced in the wrench. The motor used in the developed model for the ratchet wrench also provides the positive driving surface force in case of the torque exerted on the object while the rotation of the output shaft. The battery used in the design is the lithium battery which can be recharged. The terminals for the charging of the battery are marked to identify the charging port.

### BRIEF DESCRIPTION OF DRAWINGS: (REPLACEMENT)

FIG. 1. This latest wrench, equipped with the battery [3], is generally used to assemble, or disassemble several hardware [7] components with ease. This particular model of the wrench comparatively has many of the advanced features. By these features the time of the user can be saved, the quality work can be done and most importantly the safety of the user can be insured. That's why this wrench has novelty. Every part of this wrench has a specific and predetermined work, for effective working. The innovation in this wrench is the introduction of the electronic circuitry with the use of some hardware. The key part of this wrench is basically motor [4], which controls the overall working. Such a motor is used in this wrench, which can easily start in a very short interval and can also perform some load work without overheating or any issue. By the movement of the motor, the connected shaft will rotate and consequently it will tighten or loose the predefined hardware components. In this model, the controlling of the motor can be done by a simple push button. By pressing the push button motor will start rotating and when the pressure is removed it will stop rotating. For the more ease, the direction [6] of the motor can also be controlled by the use of the dedicated button. Basically, there are the two buttons on the cordless ratchet wrench, which are used for better performance. One button is for the trigger controlling of the ON and OFF state of the motor and the second button is to control the direction of the moving motor. There is a head [1] on this wrench, which hold the whole body, this head also has some flexibility to perform the operation on the different components. There is a lithium battery [3] connected with the motor. The source of power in this tool is basically the battery, which can be recharged any time. For the best performance of the wrench, a standard lithium ion battery is connected with the motor. For the standard charging of the battery, a proper charger is also a part of this tool. By this standard charger the battery of wrench can be easily charged in a defined amount of time. For the ease of the user, the charging sign is also printed at the charging terminal. Main body is the significant part of this latest wrench, in the main body there is a symmetry of the electronic circuitry [2] and the hardware. The wiring of the motor and the battery is also included in the main body. These wirings are insulated by the insulating material to keep the user safe from any electrical shock. The outer body of this wrench is taken as a moderate one, not as soft so that the inner components can't be broken, not as hard that the inner components can be broken.

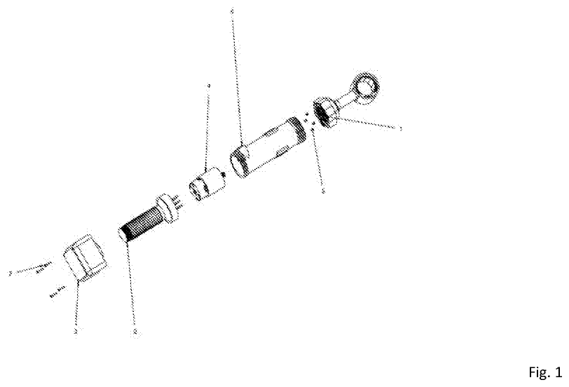

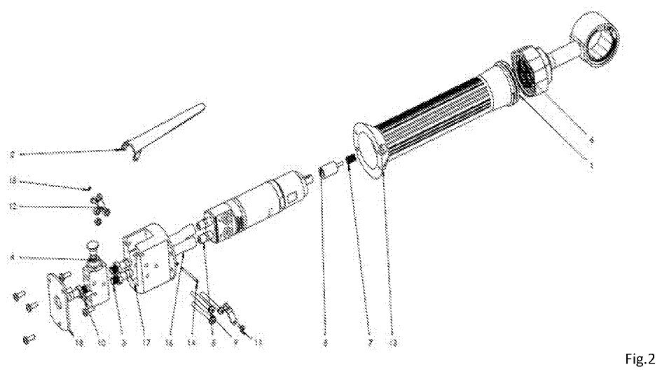

### BRIEF DESCRIPTION HEADS (REPLACEMENT)

They are basically the changeable heads, that can be used according to the different hardware components. These heads are also known as flexible heads, their shape and the size of the head depends upon the size of the bolt. In the older times, there was no concept of changeable heads. If there is a bolt having a different size, then the head of the wrench can be easily changed for the ease of working. The head is usually connected at the upper side of top head assembly. At top head assembly, all the upper components and the body is connected. The material used for the construction of removable heads is same, but there are several kinds of the removable heads, that depend upon the requirements of the work.

### REFERENCES

[1] “A New Ratchet-Wrench,” Scientific American, vol. 83, no. 2, pp. 388-388, 1900.

[2] G. H. Ander, “Screw-driver Wrench and Tap Wrench,” Scientific American, vol. 105, no. 20, pp. 433-455, November 2011.

[3] J. T. Warner, “Lithium ion Battery operation,” Lithium-Ion Battery Chemistries. Pp. 43-77, 2019.

[4] J. F. W. Schnorr, “Design of a High Temperature Air Motor,” January 1978.

1-19. (canceled)

19. The electric motor for the rotation purpose of the shaft.

20. A rechargeable lithium-ion battery with its proper housing connecting to the body which enclosure the motor in claim [1].

21. A reversal switch attached with the motor and rechargeable battery as in claim [2] to allow the alternate direction operation.

22. The output shaft for the holding of the tools.

23. The wrench of claim [1] there is the bottom edge and the top edge of the first gear. The bottom edge of the wrench is opposite to the top edge, There is a keyed slot in the first gear which is centrally disposed of. There are the teeth of the first gear which extend from the top edge of the first gear to the bottom edge. The top surface of the first gear is recessed, and the bottom surface is disposed centrally on the slot.

24. The second gear of the developed cordless ratchet wrench of claim [5] has also two edges. The bottom edge and the top edge. The bottom edge is opposite to the top edge. The second gear has the predefined and calculated aperture. The aperture of the second gear extends from the centrally disposed of aperture. The teeth of the second gear are located on the outer circumference of the gear. The teeth of the second gear also extend from top edge to bottom edge.

25. The wrench of claim [6] a ball is used in the circumferential groove, the size for the ball was predetermined and it was used for the free-rolling purpose in the developed wrench. The ball was disposed between the second and the first gear as seen in claim [5].

26. A predetermined slot is used in the first gear as in claim [5]. The shape of the wheel is circular.

27. A predetermined wheel is used in the second gear as in claim [6] which is the driver gear for the wrench. The shape of the wheel is circular.

28. The developed model or the design of the cordless ratchet wrench also uses the bearings in its structure. The circular bearings are used in the model, The size for the aperture of bearings was predefined as in claim [7]. The bearing has a shoulder that is centrally disposed of and is circular. The shoulder of the wrench extends from the aperture at a predetermined distance.

29. The wrench as in claim [6] has interchangeable head. The heads of the wrench can be easily changed to open or loosen a bolt of user choice. The interchangeable heads for the different bolts will be according to the standard and metric bolt sizes available.

30. The wrench will be operated with the art of the pneumatic impact. A pneumatic motor is used to rotate the output shaft of the wrench. The mechanical power is obtained with the help of the air motor which converts the air pressure into mechanical work. With the help of the source of the air pressure, the different kinds of fasteners are tightened or loosed.

31. The wrench of claim [1] trigger is used to operate the wrench. When the trigger is pressed the wrench will operate as per its predetermined mechanism. The flow of the air pressure is controlled with the help of the trigger to operate tightening or loosing.

32. The use of air motor as in clam [1] is perfectly aligned with the rotor rotation axis to provide a perfect rotation to the output shaft.

33. The wrench of claim [2] the output shaft is supported with the help of the hammer in the structure of the developed design to provide better control.

34. The wrench of claim [3] casing or the housing of the developed model is designed with the calculations to minimize the inertia experienced during the operation of the air ratchet wrench.

35. The wrench of claim [4] the output shaft end is changeable which can be easily changed with the required tool for the tightening or loosing of the different hardware such as nuts, screws, etc.

36. The wrench of claim [6] the cam and clutch are used in the design which is used for the interconnection of the air motor and the hammer which is used for the axial rotation.

37. The wrench of claim [1] the housing of the motor includes the proper space for the clutch, air motor, hammer, can and anvil. The housing of the motor is kept airtight.

38. The changeable heads of the wrench as in claim [6] will be easily changed with the desired type of fastener.

39. The wrench of claim [9] has standard and metric sizes heads for the bolts will be attachable or detachable with the output shaft of the air ratchet wrench.
